(19) United States
(12) Patent Application Publication
(10) Pub. No.: US 2004/0045000 A1
(43) Pub. Date: Mar. 4, 2004

(54) Software license management system and method and recording medium

(75) Inventor: Yutaka Hara, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/653,143

(22) Filed: Sep. 3, 2003

(30) Foreign Application Priority Data
Sep. 4, 2002 (JP) 259056/2002

(51) Int. Cl. G06F 9/445; G06F 9/44

(52) U.S. Cl. 717/178; 717/173

(57) ABSTRACT

Upon receiving a request to install a software package, a user device running an installer builder contained in a medium connects to a seller's server, requests the installer from the seller's server, and thereby checks whether the software package contained in the medium has already been installed, where the seller's server manages installation information in an installation management database on a medium-by-medium basis. If it is found that the software package has not been installed, the user device installs the software package from the medium by executing an installer downloaded from the seller's server. After the installation, the software package in the medium is managed as having been installed.

### BACKGROUND OF THE INVENTION

1. Field of the Invention

The present invention relates to a software license management system, software license management method, and recording medium, and more particularly, to a software license management system, software license management method, and recording medium intended to protect the licensees of software packages and prevent the use of illegally copied software.

2. Description of the Related Art

Conventionally, commercial software packages are provided as executable file systems equipped with an installer which allows even users who are not familiar with personal computers to install the software.

Regarding license management of software provided with an installer, under typical conventional technologies, many software packages are sold without a mechanism for technical management. However, purchasers of such software packages are not supposed to use them without a license due to legal and moral constraints. Furthermore, under the status quo, if a software package is intended for individual users, only the person who purchased a package has the right to use it, and it is illegal to use its copies.

One of the methods for verifying software installation on a server is disclosed in Japanese Patent Laid-Open No. 2001-265588. It works as follows: when a purchaser's computer sends installation information including a number unique to a recording medium to a seller's computer, the seller's computer checks the number of licenses given to each unique number by consulting managerial storage means, and grants permission to install the software on the purchaser's computers from a CD-ROM if the number of licenses purchased is not exceeded.

However, the above described typical technologies without a mechanism for technical management actually rely on moral senses of individuals. Otherwise, there is no way of preventing software installation using an installer. In the case of software packages for corporate users, package licensing makes it possible to limit the number of users allowed to use the software. Here again, however, moral senses of the corporate users must be relied on. Increases in the use of illegal copies will decrease software purchases and cause losses to the seller.

Also, with the above described method for verifying software installation on a server, the installer exists on the personal computer and constitutes an executable file system which allows even users who are not familiar with personal computers to install the software. This presents a problem because programs can be modified.

Furthermore, with the above described method for verifying software installation on a server, if a user who has one license wants to uninstall programs from a first computer and reinstall them on a second computer, for example, to replace the first computer with the second, the programs once installed cannot be installed again on the second computer even if they can be uninstalled from the first computer because they are regarded as having already been installed.

### SUMMARY OF THE INVENTION

An object of the present invention is to solve the above problems, i.e., to prevent illegal copying of software, and thereby, prevent unauthorized use of the software and decreases in software vendors' sales volumes.

Another object of the present invention is to provide a system which makes it possible to replace a terminal on which a software product is used within the scope of a current software license agreement while preventing illegal copying of software.

Currently, commercial software packages are provided as executable file systems equipped with an installer which allows even users who are not familiar with personal computers to install the software. To operate a software package on a personal computer, portable telephone, or PDA (hereinafter referred to representatively as a personal computer), the installer performs a series of settings: creates folders, extracts DLL files and OCX files to predetermined OS areas, and initializes and loads the OS and the configuration file of the software package. The content of the installer can be determined uniquely during the development of the software package. The problem with the installer, which is distributed on a medium such as a CD-ROM, lies in the fact that it allows anyone, whether the purchaser or not, to install and use the software stored on the CD-ROM or the like.

Without an installer, it is very difficult for users who lack computer expertise to copy or otherwise move software from a personal computer to another personal computer. Therefore, if the installer is removed once the software is installed, illegal copies can be reduced greatly. The present invention can prevent illegal copying because the software package erases the installer on the medium upon installation of the software package.

However, if the installer is erased, even the legitimate purchaser cannot uninstall the software package from a first personal computer and reinstall it on a second personal computer when replacing the first personal computer with the second personal computer.

In contrast, according to the present invention, to replace a personal computer on which a software package has already been installed (hereinafter referred to as a source computer), the software package has capabilities (an installer builder) to create an installer, uninstall the software package using the created installer, and install the software package on the destination computer using the created installer again. Thus, according to the present invention, to move a software package to another personal computer, the legitimate purchaser of the software package can start the installer builder.

Currently, software is sold on a CD-ROM, which contains the installer. Since the CD-ROM is not rewritable, it is not possible to erase the installer alone after installation or write the installer created again into the CD-ROM. Thus, it is necessary to distribute and manage the installer alone on amide other than CD-ROM. According to the present invention, installers are provided on the Internet. They are distributed by a seller's server on the Internet. In this case, it is not necessary for software packages to create an installer. Also, since the installers are provided centrally on the seller's server, there is not need to provide an installer for each purchased license. All that is required of the installer is to uninstall the software package. The destination computer can download the installer from the server by connecting to the Internet. The seller's server manages downloading and deletion of installers for each purchaser. It also manages multiuser licenses for corporate users. This method can prevent installers from being downloaded illegally from the seller's server, and two or more copies from being installed illegally for one license.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram showing a configuration of a first embodiment of the present invention;

FIG. 2 is a schematic diagram outlining an internal configuration of the installation management database shown in FIG. 1;

FIG. 3 is a state transition diagram showing state transitions in the installation management database which manages installation status of a software package contained in the medium shown in FIG. 1;

FIG. 4 is a sequence diagram showing operations performed between a user device and seller's server when a purchaser installs the software package on the user device shown in FIG. 1;

FIG. 5 is a sequence diagram showing operations performed between user device and seller's server when a purchaser uninstalls the software package from the user device shown in FIG. 1;

FIG. 6 is a flowchart showing operations performed when the user device executes an installer builder contained in a medium 2;

FIG. 7 is a flowchart showing operations performed by the seller's server to process a user registration request, installer request, and uninstallation-complete notice received from the user device;

FIG. 8 is a block diagram showing a configuration of a second embodiment of the present invention; and

FIG. 9 is a flowchart showing operations performed when the user device shown in FIG. 8 executes an installer builder contained in a medium.

### DETAILED DESCRIPTION OF PREFERRED EMBODIMENTS

Preferred embodiments of the present invention will be described below in detail with reference to the drawings.

A first embodiment of the present invention will be described with reference to drawings.

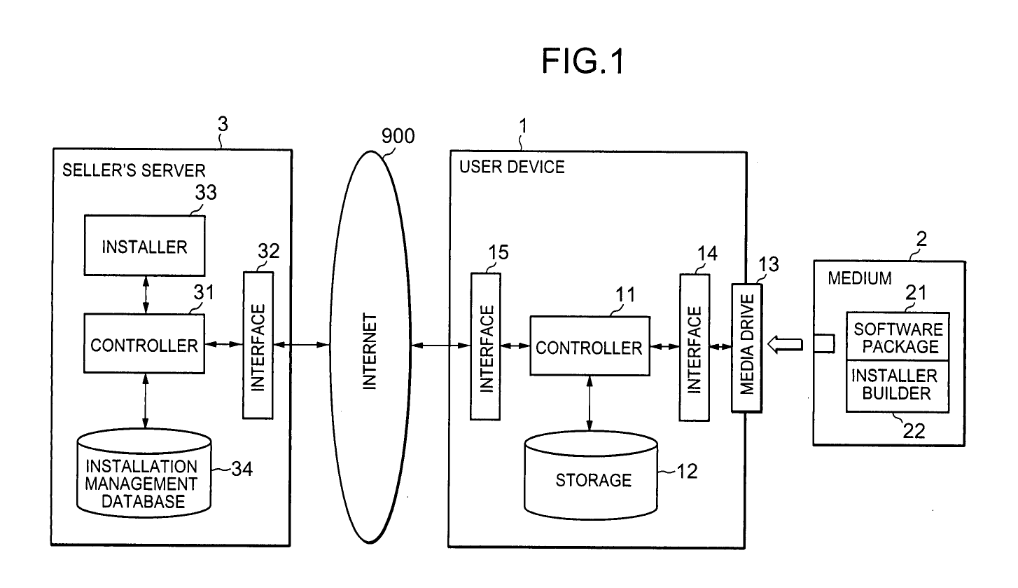

FIG. 1 is a block diagram showing a system according to the first embodiment of the present invention. The system in FIG. 1 comprises a seller's server 3 used by the seller of a software package to manage the software package, a user device 1 used by a user who purchases the software package, and a medium 2 which is a recording medium such as a CD-ROM, DVD-R, or MO. The user device 1 and seller's server 3 are connected via the Internet 900.

The user device 1 in FIG. 1 is a personal computer which installs software from the medium 2 and has communications capabilities for connecting to the Internet. It comprises a controller 11 which operates under program control from a processor (CPU) not shown, interface 15 which exchanges data with the Internet 900, media drive 13 (such as a CD-ROM drive, MO drive, CD-R/W drive, DVD-R/W drive, or FD drive) which reads the medium 2 under the control of the controller 11, interface 14 which exchanges data with the media drive 13, and storage 12. It is assumed that the user of the user device 1 has set up an account with a provider to access the seller's server 3.

The seller's server 3 in FIG. 1 comprises a controller 31 which operates under program control from a processor (CPU) not shown, interface 32 which exchanges data with the Internet 900, installer 33, and installation management database 34.

The installer 33 in FIG. 1 is a program which is stored on a non-volatile recording medium (e.g., magnetic disk, optical disk, or the like) not shown, is downloadable onto the user device 1, and is used to install a software package 21 on the user device 1 from the medium 2. The medium 2 does not contain the installer 33.

The installation management database 34 in FIG. 1 resides on a non-volatile recording medium (e.g., magnetic disk) not shown. For each medium 2 (media identification number) bought by a purchaser, it contains information as to whether the installer 33 has been downloaded from the seller's server 3 and whether the software package 21 has been installed from the medium 2.

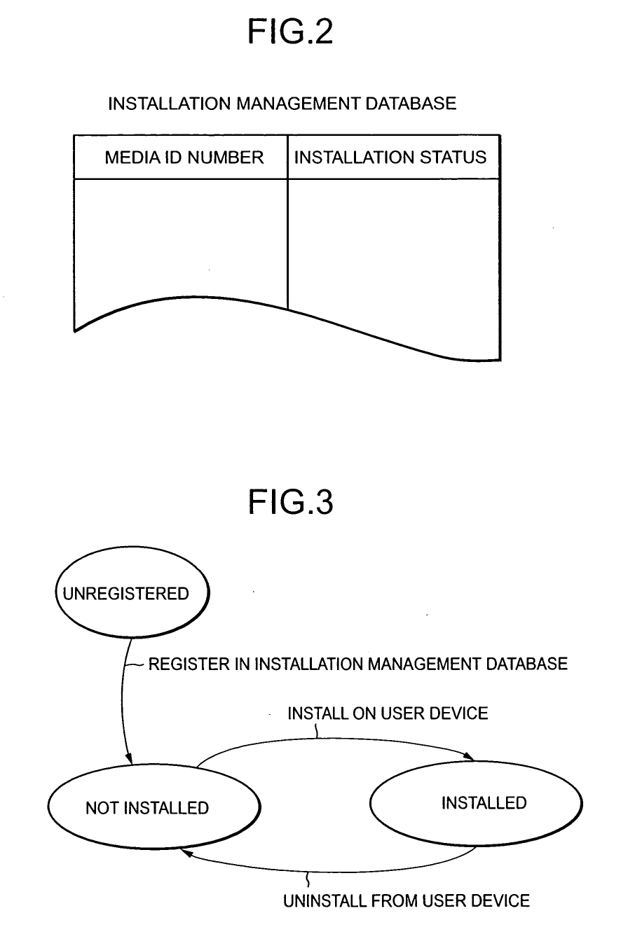

FIG. 2 shows a configuration example of the installation management database 34, which comprises a media ID column and installation status column to allow management by the media identification number. For each media identification number registered in the installation management database 34, the installation status column contains, for example, “Not Installed” by default and contains, for example, “Installed” when the installer 33 is downloaded and the software package 21 is installed on the user device 1.

FIG. 3 is a schematic diagram showing changes in the installation status managed for the user device 1 by the installation management database 34 of the seller's server 3. In the initial state when no license for the software package is sold, the installation management database 34 contains “Unregistered.” When a license is sold, its media identification number is registered in the installation management database 34 and the installation status field for this license (media identification number) contains “Not Installed.” The “Not Installed” status means that an installer download request will be accepted. Once the installer 33 is downloaded and the software package 21 is installed on the user device 1, the installation status field for this license contains “Installed.” When the installation status is “Installed,” any attempt to download the installer 33 from the seller's server 3 to the user device 1 is rejected by the controller 31 of the seller's server 3.

In addition to the software package 21, the medium 2 contains an installer builder 22 which has different functions. The installer builder 22 has two operating patterns. The first operating pattern is used if the software package 21 has not been installed on the user device 1 when it is requested to be installed. It involves connecting to the seller's server 3 via the Internet 900, downloading the installer 33, making the downloaded installer 33 install the software package 21 on the user device 1, and deleting the installer 33. The second operating pattern is used if the software package 21 has been installed on the user device 1 when it is requested to be uninstalled. It involves connecting to the seller's server 3 via the Internet 900 automatically, setting the installation status field for the appropriate media identification number to “Not Installed,” and uninstalling the software package 21 from the user device 1.

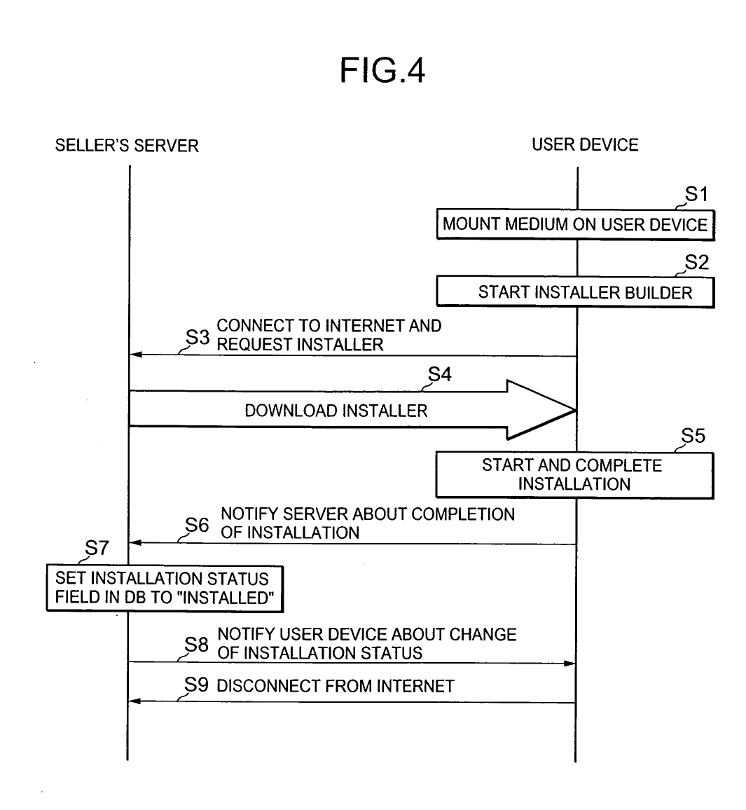

FIG. 4 is a sequence diagram showing a sequence of operations performed between the user device 1 and seller's server 3 from the time the software package 21 is purchased to the time it is installed on the user device of the purchaser. The user device 1 is ready to connect to the Internet 900 using the point-to-point protocol (PPP), a LAN, or the like.

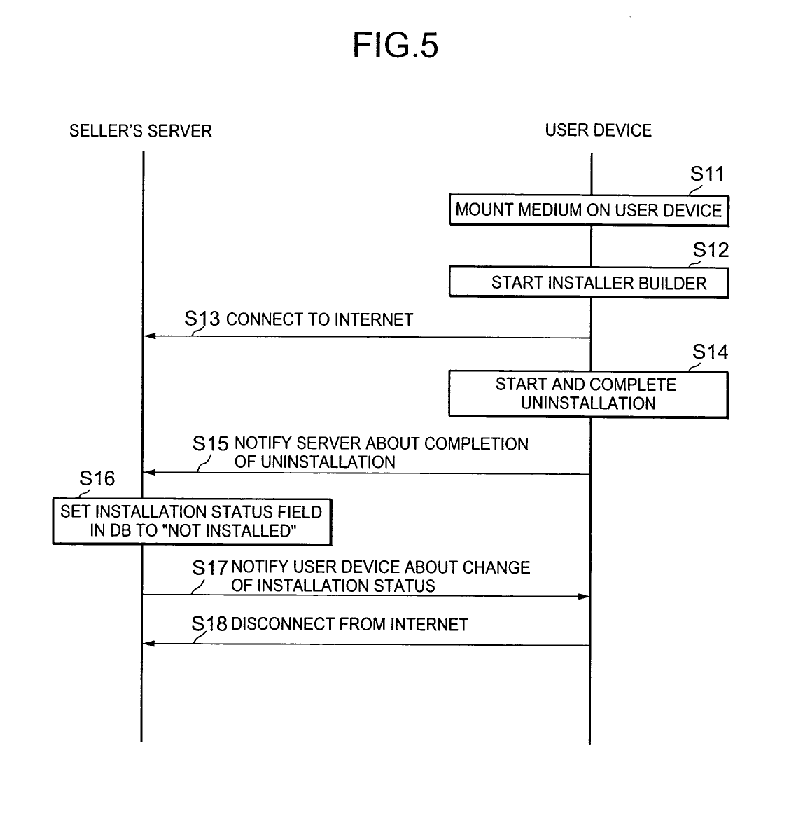

FIG. 5 is a sequence diagram showing a sequence of operations performed between the user device 1 and seller's server 3 when a purchaser uninstalls the software package 21 from the user device 1.

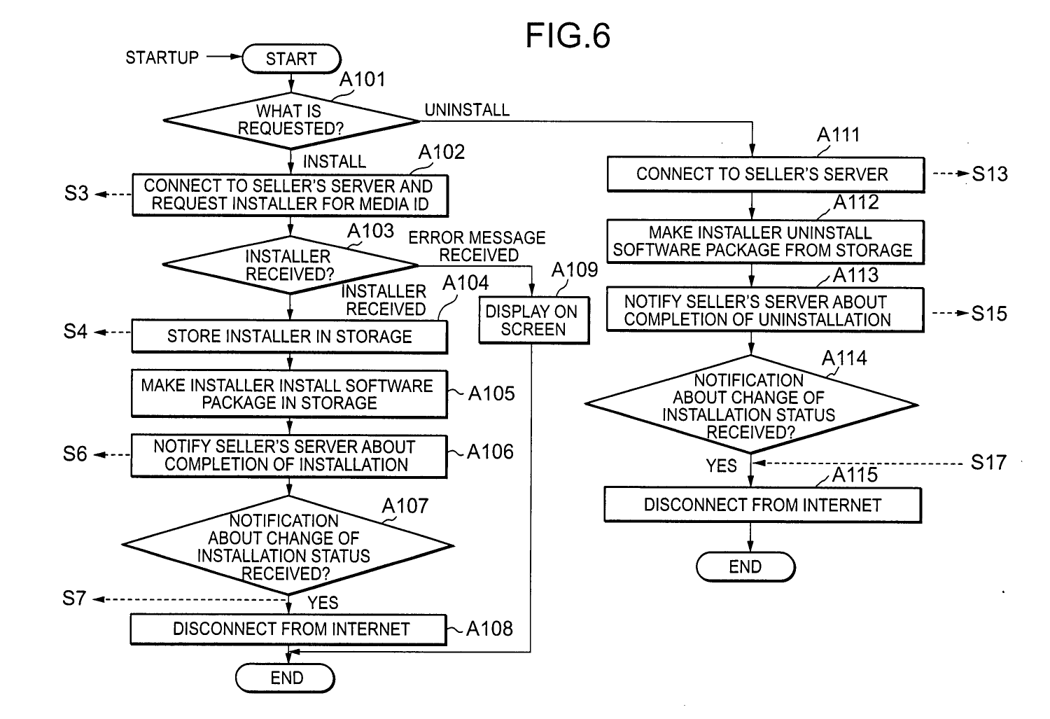

FIG. 6 is a flowchart showing operations performed when the controller 11 of the user device 1 executes the installer builder 22 contained in the medium 2.

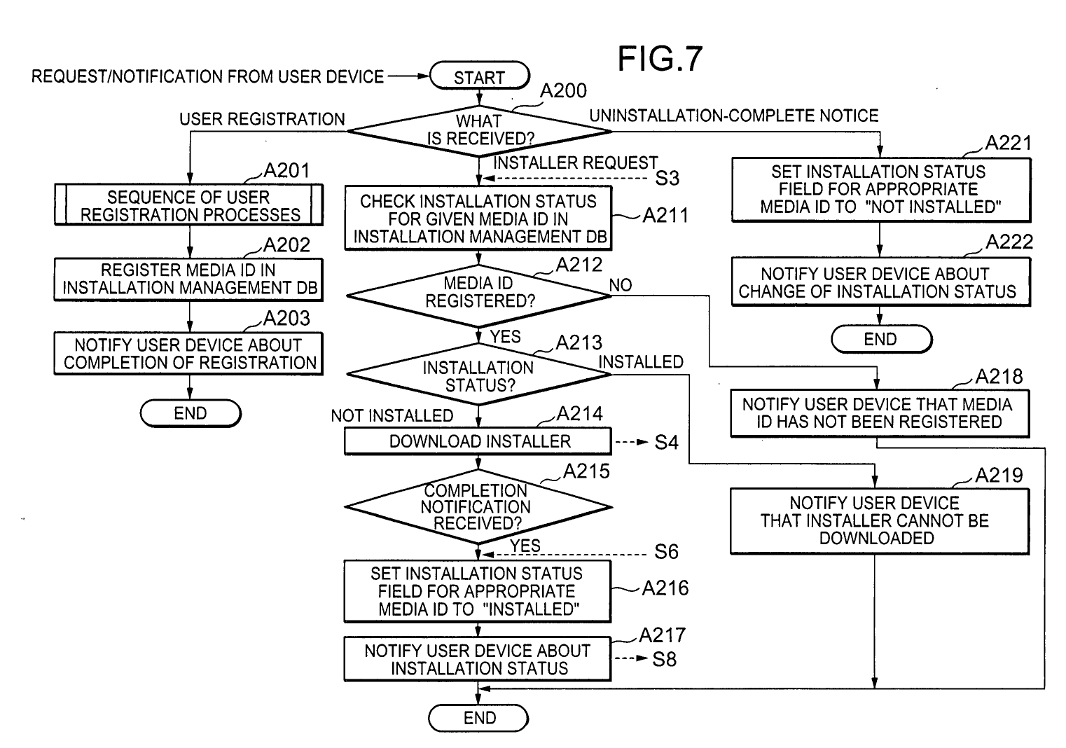

FIG. 7 is a flowchart showing operations performed by the controller 31 of the seller's server 3 to process a user registration request, installer request, and uninstallation-complete notice received from the user device 1.

Next, the first embodiment of the present invention will be described with reference to FIGS. 1 to 9.

To begin with, description will be given of a case in which the medium 2 is purchased and the software package 21 contained in the medium 2 is installed on the user device 1, mainly with reference to FIGS. 4, 6, and 7.

When the purchaser buys the medium 2 containing the software package 21 and installer builder 22 and makes a user registration request from the user device 1 via the Internet 900, the controller 31 of the seller's server 3 receives the user registration request via the interface 32, performs a sequence of user registration processes, and registers the media identification number of the medium 2 in a media ID field of the installation management database 34 (Steps A201 and A202 in FIG. 7). Incidentally, the user registration processes above include, for example, the processes of allowing the user to enter the media identification number, purchaser name, address, e-mail address, etc. in a predetermined registration request form and registering the user in a user management database (not shown) based on the entries of the registration request form.

The controller 31 of the seller's server 3 notifies the user device 1 about the completion of the registration via the interface 32 and finishes processing (Step A203).

When the purchaser of the software package completes registration and mounts the medium 2 on the media drive 13 of the user device 1 to run the installer builder 22, the controller 11 of the user device 1 starts the installer builder 22 (Sequences S1 and S2 in FIG. 4).

The controller 11 which reads the installer builder 22 from the medium 2 and executes it displays a menu on a screen (not shown). When the purchaser selects “Install” from the menu screen, the controller 11 automatically starts up a browser running on the user device 1, connects to the Internet, and requests the installer 33 from the seller's server 3 (Sequence S3 in FIG. 4 and Steps A101 and A102 in FIG. 6). When requesting the installer 33, the controller 11 attaches the media identification number read out of the medium 2 to the request.

Upon receiving the request for the installer 33 for the medium 2 with the media identification number from the user device 1 via the Internet 900 and interface 32, the controller 31 of the seller's server 3 checks whether the given media identification number has been registered with the installation management database 34. If it has been, the controller 31 checks the installation status field for the given media identification number in the installation management database 34. If the installation status is “Not Installed” (it is set to “Not Installed” in this case because the given software package is newly purchased), the controller 31 downloads the installer 33 to the user device 1 via the interface 32 (Sequence S4 in FIG. 4 and Steps A200 and A211 to A214 in FIG. 7).

If it is found in Step A212 that the media identification number has not been registered, the controller 31 of the seller's server 3 finishes processing by sending an error message to the requesting user device 1, stating that the media identification number has not been registered and prompting the user to register (Step A218).

If it is found in Step A213 that the installation status is “Installed,” the controller 31 of the seller's server 3 finishes processing by sending a Download Request Rejected message (error message) to the requesting user device 1, indicating that the installer cannot be downloaded because the software has already been installed (Step A219).

Upon receiving the installer 33 downloaded via the interface 15, the controller 11 of the user device 1 stores the installer 33 in a predetermined area of the storage 12 and executes the stored installer 33. Then, the controller 11 executing the installer 33 installs the software package 21 in a predetermined area of the storage 12 from the medium 2. After finishing the installation performed by the installer 33, the controller 11 notifies the seller's server 3 about the completion of the installation using the installer builder 22 (Sequences S5 and S6 in FIG. 4 and Steps A101 to A106 in FIG. 6).

Upon receiving the notification about the completion of the installation via the interface 32, the controller 31 of the seller's server 3 recognizes that the license of the purchaser is used and changes the entry of the installation status field for the appropriate media identification number in the installation management database 34 from “Not Installed” to “Installed” (Sequence S7 in FIG. 4 and Steps A215 and A216 in FIG. 7).

After setting the installation status to “Installed,” the controller 31 of the seller's server 3 notifies the user device 1 about the change of installation status (Sequence S8 in FIG. 4 and Step A217 in FIG. 7).

Upon receiving the notification about the change of installation status, the controller 11 of the user device 1 completes the installation operation by disconnecting from the Internet (Sequence S9 in FIG. 4 and Steps A107 and A108 in FIG. 6).

If an error message resulting from A218 or A219 is received via the interface 15 in Step A103, the controller 11 of the user device 1 finishes processing by displaying the error message on screen (Step A109 in FIG. 6).

Now one software package has been installed on one user device 1 and any attempt to install the software package additionally to another user device will fail, preventing illegal use of the software package because the seller's server 3 recognizes that the software package has been “Installed” and does not allow the installer to be downloaded as shown in Steps A213 and A219 in FIG. 7.

Next, description will be given of a case in which the purchaser moves a software package to a different user device 1. Since the purchaser has only one license, he/she must uninstall the software package from the source user device-1 before reinstalling it on another user device 1. Thus, the procedures involved are roughly divided into two sets of procedures: uninstallation procedures for uninstalling the software package from the source personal computer and installation procedures for installing the software package anew.

The purchaser mounts the medium 2 on the media drive 13, makes the user device 1 from which the software package will be uninstalled ready to connect to the Internet, and starts the installer builder 22 contained in the medium 2 (Sequences S11 and S12 in FIG. 5).

The controller 11 of the user device 1 which reads the installer builder 22 from the medium 2 and executes it displays a menu on a screen (not shown). When the purchaser selects “Uninstall” from the menu screen, the controller 11 starts up a browser running on the user device 1 and connects to the seller's server 3 via the Internet 900 (Sequence S13 in FIG. 5 and Step A111 in FIG. 6).

The controller 11 running the installer builder 22 makes the installer 33 uninstall the software package 21 from the storage 12 of the user device 1. When the software package 21 is uninstalled, the controller 11 that runs the installer builder 22 notifies the seller's server 3 about the completion of the uninstallation (Sequence S14 in FIG. 5 and Steps A112 and A113 in FIG. 6).

Upon receiving the notification about the completion of the uninstallation, the controller 31 of the seller's server 3 changes the entry of the installation status field for the appropriate media identification number in the installation management database 34 from “Installed” to “Not Installed” (Sequence S16 in FIG. 5 and Step A221 in FIG. 7).

After changing the entry of the installation status field, the controller 31 of the seller's server 3 notifies the user device 1 about the completion of the uninstallation (Sequence S17 in FIG. 5 and Steps A222 in FIG. 7).

Upon receiving the notification about the completion of the uninstallation, the controller 11 of the user device 1 completes the uninstallation operation by disconnecting from the Internet (Sequence S18 in FIG. 5 and Steps A114 and A115 in FIG. 6).

Now there is no user device 1 on which the software package 21 has been installed, and thus, the installer can be downloaded from the seller's server 3.

The second stage concerns procedures for installing the software package 21 on another user device 1. They are exactly the same as those shown in the operation sequence diagram in FIG. 4. Specifically, they involve connecting the user device 1 on which the software package 21 is to be installed to the Internet, starting the installer builder 22, and installing the software package 21 again. Since the operations involved are the same as those described mainly with reference to FIGS. 4, 6, and 7, and thus description thereof will be omitted.

Next, a second embodiment of the present invention will be described with reference to drawings.

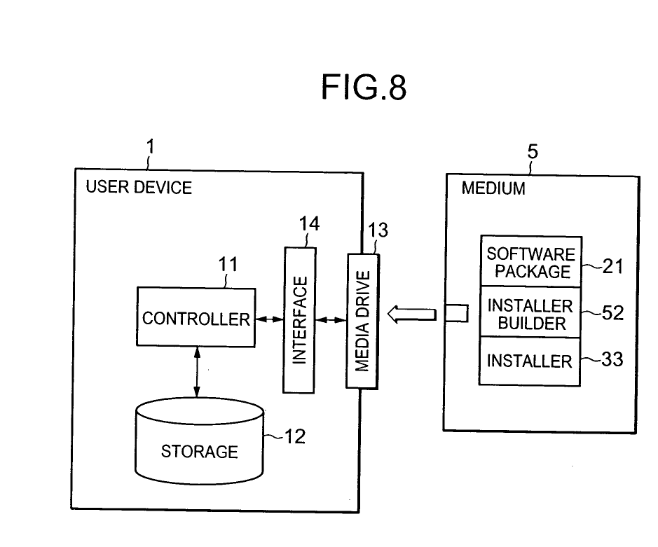

FIG. 8 is a block diagram showing a configuration of the second embodiment of the present invention. The second embodiment comprises the user device 1 and a medium 5 which is a writable recording medium such as a CD-R/W.

The medium 5 in FIG. 8 contains the software package 21, an installer builder 52, and an installer 33.

The user device 1 in FIG. 8 is a personal computer which installs the software package 21 in the storage 12 from the medium 5.

The second embodiment of the present invention differs from the first embodiment, according to which the seller's server 3 on the Internet manages the installer and installation information, in that the medium 5, which is a writable recording medium such as a CD-R/W, contains an installer as well as an installer builder.

Thus, compared to the first embodiment, the user device 1 is the same as the one in FIG. 1, the medium 5 replaces the medium 2 in FIG. 1, and the installer 33 is stored on the medium 5 rather than on the seller's server 3 in FIG. 1. The software package 21 in the medium 5 is the same as the software package in the medium 2 in FIG. 1, but the installer builder 52 is different from the installer builder 22 in FIG. 1.

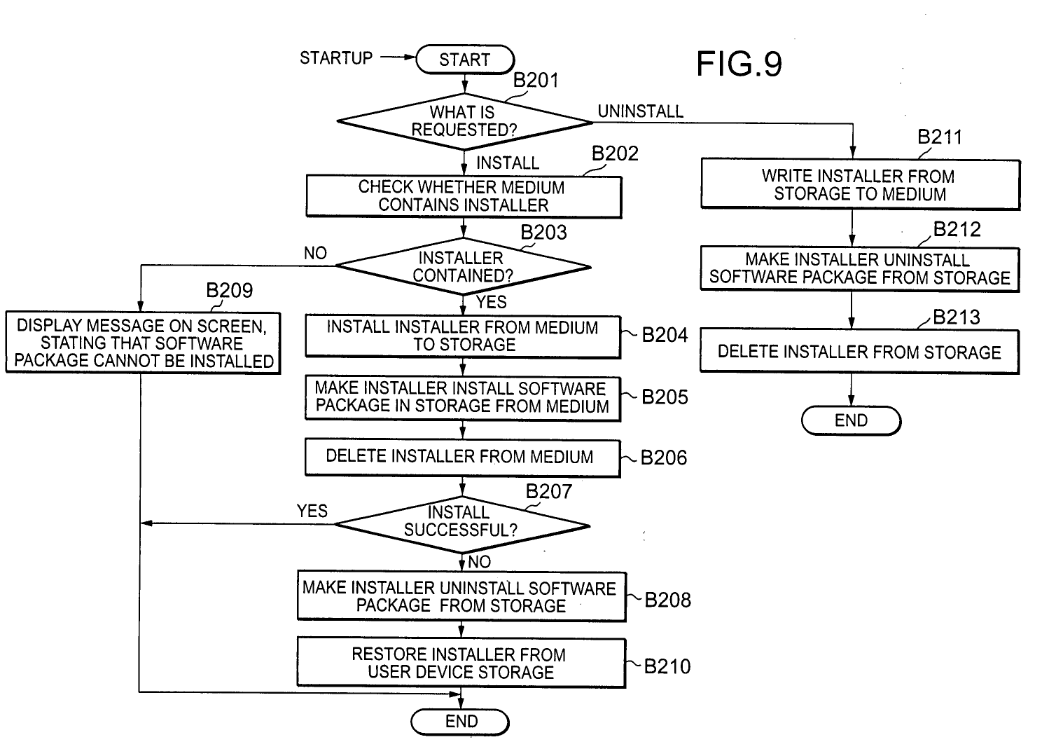

FIG. 9 is a flowchart showing operations performed when the controller 11 shown in FIG. 8 executes the installer builder 52 contained in the medium 5.

Next, operation of the second embodiment will be described with reference to FIGS. 8 and 9.

When the purchaser of the medium 5 containing the software package 21 mounts the medium 5 on the media drive 13 of the user device 1 to install the software package 21 by running the installer builder 52, the controller 11 of the user device 1 starts the installer builder 52.

The controller 11 which reads and executes the installer builder 52 displays a menu on a screen (not shown), prompting the user to select one of them. When the purchaser selects “Install,” the controller 11 checks whether the medium 5 contains the installer 33 (Steps B201, B202, and B203 in FIG. 9).

As purchased, the medium 5 contains the installer 33, and thus the controller 11 installs the installer 33 in a predetermined area of the storage 12 from the medium 5 (Step B204).

After installing the installer 33 in the storage 12, the controller 11 starts the installer 33 installed in the storage 12. Then, the controller 11 running the installer 33 installs the software package 21 in a predetermined area of the storage 12 from the medium 5. In other words, the controller 11 running the installer builder 52 makes the installer 33 install the software package 21 in the storage 12 from the medium 5 (Step B205).

Then, the controller 11 deletes the installer 33 from the medium 5 (Step B206).

When installation is successful, the controller 11 finishes the installation operation, but if installation is not successful, the controller 11 makes the installer 33 uninstall the software package from the storage 12 before finishing processing (Steps B207 and B208). The process in Step B206 is intended to prevent the user from finishing the installation operation intentionally without mounting the medium 5 on the media drive 13. And the process in Step B210 is intended to write the installer 33 into the medium 5 because the installer 33 is deleted at the process in Step B206.

If it turns out in Step B203 that the medium 5 does not contain the installer 33, the controller 11 finishes processing by displaying an error message (Unable to install software package) on screen, indicating that the software package has already been installed and cannot be installed any more (Step B209).

Next, description will be given of a case in which the purchaser uninstalls the software package 21 from the user device 1.

When the purchaser mounts the medium 5 on the media drive 13 of the user device 1 to uninstall the software package 21 from the user device 1 by running the installer builder, the controller 11 of the user device 1 starts the installer builder 52.

The controller 11 which reads and executes the installer builder 52 displays a menu on a screen, prompting the user to select one of them. When the purchaser selects “Uninstall,” the controller 11 writes the installer 33 into the medium 5 from the storage 12 (Steps B201 and B211 in FIG. 9).

The controller 11 makes the installer 33 in the storage 12 uninstall the software package 21 from the storage 12 (Step B212).

After the installer 33 uninstalls the software package 21, the controller 11 deletes the installer 33 from the storage 12 and finishes the installation operation (Step B213).

According to the second embodiment described above, after the software package 21 is installed, the installer is deleted from the rewritable medium 5. On the other hand, when the software package 21 is uninstalled from the source user device 1, the installer 33 is deleted together from the user device 1 after it is written into the medium 5. Consequently, the check in Step B202 ensures that only one copy of the software package 21 can be installed for one license.

Incidentally, it goes without saying that in the first and second embodiments, the medium which contains the installer builder does not affect the operation of the installer builder whether it is a CD-R, CD-ROM, CD-R/W, DVD, or MO.

Also, although the media drive 13 is incorporated in the user device according to the first and second embodiments described above, even if it is provided externally, needless to say, it is also included in the present invention with no difference in configuration.

Also, although it has been explained that the user device 1 is a personal computer, the present invention is also applicable to processor-based (CPU-based) information processing units such as PDAs (Personal Digital (Data) Assistants) and portable telephones. In that case, connections to the Internet 900 are provided by a carrier that manages a wireless network used by the PDA or portable telephone, while the storage 12 in the user device 1 is a non-volatile memory (e.g., flash memory).

According to the first embodiment, once the user device 1 running the installer builder 22 installs the software package 21 using the installer 33 downloaded from the seller's server, the seller's server 3 recognizes that the software package has already been installed and does not allow the installer 33 to be downloaded even if requested by the given user device 1 or another user device 1 with the same media identification number, and thus, the other user device 1 cannot install the software package 21 from this medium 2.

According to the second embodiment, once the user device 1 running the installer builder 52 installs the software package 21 from the medium 5 using the installer 33 contained in the medium 5, the installer 33 is deleted from the medium 5, making the installer unavailable even if requested by the given user device 1 or another user device 1, and thus, the other user device 1 cannot install the software package 21 from this medium 5.

In this way, the first and second embodiments prevent illegal copying of software packages, and thereby, prevent unauthorized use of the software packages and decreases in software vendors' sales volumes. This offers a form of selling which does not inconvenience the purchaser who wants to reinstall a software package.

Also, the first or second embodiment allow the user who has installed the software package 21 on a user device 1 to install it on another user device 1 after uninstalling it from the first user device 1.

As described above, according to the present invention, once a user device running an installer builder installs a software package using a downloaded installer, the seller's server recognizes that the software package has already been installed and does not allow the installer to be downloaded even if requested by another user device with the same media identification number. This prevents the other user device from installing the software package from the medium. Thus, the present invention prevents illegal copying of software packages, makes the number of software users agree with the number of software packages sold, and normalizes software manufacturers' and vendors' sales.

Also, according to the present invention, once a user device running an installer builder installs a software package using an installer contained in a medium, the installer is deleted from the medium, making the installer unavailable even if requested by another user device. This prevents the other user device from installing the software package from the medium. Thus, the present invention prevents illegal copying of software packages, makes the number of software users agree with the number of software packages sold, and normalizes software manufacturers' and vendors' sales.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A software license management system which allows a user device to install a software package contained in a medium by executing an installer dedicated to the software package, the software license management system comprising:
a first connecting unit which, when the user device is requested to install the software package, allows the user device to connect via the Internet to a server that manages the medium containing the software package;
a requesting unit which requests the installer from the server, and thereby checks whether the software package contained in the medium has been installed on the user device;
an installing unit which downloads the installer from the server and installs the software package contained in the medium by executing the downloaded installer if the check by the requesting unit reveals that the software package has not been installed on the user device; and
a first notifying unit which, when the installing unit finishes installation, notifies the server about the completion of the installation of the software package in order for the software package contained in the medium to be managed as having been installed on the user device.

2. The software license management system according to claim 1, further comprising:
a second connecting unit which, when the user device is requested to uninstall the software package, allows the user device to connect via the Internet to the server that manages the software package;
an uninstalling unit which uninstalls the software package from the user device by executing the installer downloaded onto the user device; and
a second notifying unit which, when the uninstalling unit finishes uninstallation, notifies the server about the completion of the uninstallation of the software package in order for the software package contained in the medium to be managed as being not installed on the user device.

3. The software license management system according to claim 1, wherein the server comprises a downloading unit which downloads the installer, if requested by the user device, from the server to the requesting user device, by determining that the software package has not been installed if installation status for an appropriate identification number is “Not Installed.”

4. The software license management system according to claim 2, wherein the server comprises a downloading unit which downloads the installer, if requested by the user device, from the server to the requesting user device, by determining that the software package has not been installed if installation status for an appropriate identification number is “Not Installed.”

5. The software license management system according to claim 3, wherein the server further comprises a managing unit which manages the installation status for the appropriate identification number as being “Installed” if notification about the completion of the installation of the software package is received from the user device, and manages the installation status for the appropriate identification number as being “Not Installed” if notification about the completion of the uninstallation of the software package is received from the user device.

6. The software license management system according to claim 4, wherein the server further comprises a managing unit which manages the installation status for the appropriate identification number as being “Installed” if notification about the completion of the installation of the software package is received from the user device, and manages the installation status for the appropriate identification number as being “Not Installed” if notification about the completion of the uninstallation of the software package is received from the user device.

7. The software license management system according to claim 2, wherein the server comprises:
a database for managing installation status which indicates for each media identification number whether the software package has been installed;
a downloading unit which downloads the installer, if requested by the user device, from the server to the requesting user device, by determining that the software package has not been installed if installation status for an appropriate identification number is “Not Installed;” and
a managing unit which manages the installation status for the appropriate identification number as being “Installed” if notification about the completion of the installation of the software package is received from the user device, and manages the installation status for the appropriate identification number as being “Not Installed” if notification about the completion of the uninstallation of the software package is received from the user device.

8. The software license management system according to claim 7, wherein the server further comprises a sending unit which sends an error message to the user device which requests the installer, stating that the software package has been installed if the installation status for the identification number of the appropriate medium is “Installed.”

9. A software license management system which allows a user device to install a software package from a rewritable medium using an installer dedicated to the software package, wherein:
the medium contains an installer builder and an installer; and
the user device comprises:
a first installing unit which installs the installer from the medium to the user device if requested to install the software package when the installer builder contained in the medium is executed,
a second installing unit which installs the software package from the medium to the user device by running the installer installed by the first installing unit, and
a first deleting unit which deletes the installer from the medium after the software package is installed by the second installing unit.

10. The software license management system according to claim 9, wherein the user device further comprises:
a writing unit which writes the installer from the user device to the medium if requested to uninstall the software package when the installer builder contained in the medium is executed;
an uninstalling unit which uninstalls the software package from the user device; and
a second deleting unit which deletes the installer from the user device after the software package is uninstalled by the uninstalling unit.

11. A software license management method which allows a user device to install a software package from a medium using an installer dedicated to the software package, the software license management method comprising the steps of:
connecting via the Internet to a server that manages each medium containing the software package, when the user device is requested to install the software package which is running an installer builder contained in the medium;
requesting the installer from the server, and thereby checking whether the software package has been installed on the user device from the medium;
downloading the installer from the server and installing the software package from the medium by executing the downloaded installer if the check reveals that the software package has not been installed on the user device; and
notifying the server about the completion of the installation of the software package after the installation in order for the software package contained in the medium to be managed as having been installed on the user device.

12. The software license management method according to claim 11, further comprising the steps of:
uninstalling the software package from the user device by executing the installer downloaded onto the user device when the user device is requested to uninstall the software package which is running the installer builder contained in the medium; and
notifying the server connected to the Internet about the completion of the uninstallation of the software package after the uninstallation in order for the software package contained in the medium to be managed as being not installed on the user device.

13. The software license management method according to claim 11, wherein:
the server is equipped with a database for managing installation status which indicates for each media identification number whether the software package has been installed; and
the software license management method further comprises the steps of:
connecting the user device to the server via the Internet and requesting the installer when the user device is requested to install the software package which is running the installer builder;
downloading the installer stored in advance in the server to the requesting user device if the installation status for the appropriate identification number in the database is “Not Installed” when the installer is requested by the user device;
installing the software package on the user device from the medium as the user device executes the installer downloaded from the server;
sending an installation-complete notice to the server when the user device installs the software package on the user device; and
setting the installation status for the appropriate identification number in the database to “Installed” when the server receives the installation-complete notice.

14. The software license management method according to claim 13, further comprising the steps of:
making the server send an error message to the user device which requests the installer, stating that the software package has been installed if the installation status for the appropriate identification number in the database is “Installed;” and
prohibiting the user device from installing the software package from the medium if the error message is received.

15. The software license management method according to claim 13, further comprising the steps of:
making the user device connect to the server via the Internet when the user device is requested to install the software package which is running the installer builder;
making the user device uninstall the software package from the user device by executing the installer downloaded onto the user device;
making the user device send an uninstallation-complete notice to the server, stating that uninstallation is complete, when the software package is uninstalled from the user device;
making the server set the installation status for the appropriate identification number in the database to “Not Installed” when the notification about the completion of the uninstallation of the software package is received from the user device.

16. The software license management method according to claim 14, further comprising the steps of:
making the user device connect to the server via the Internet when the user device is requested to install the software package which is running the installer builder;
making the user device uninstall the software package from the user device by executing the installer downloaded onto the user device;
making the user device send an uninstallation-complete notice to the server, stating that uninstallation is complete, when the software package is uninstalled from the user device;
making the server set the installation status for the appropriate identification number in the database to “Not Installed” when the notification about the completion of the uninstallation of the software package is received from the user device.

17. A software license management method which allows a user device to install a software package from a rewritable medium using an installer dedicated to the software package, wherein:
the medium contains in advance an installer builder and an installer; and
the software license management method comprises the steps of:
making the user device install the installer on itself from the medium if the software package is requested to be installed,
making the user device install the software package on itself from the medium by running the installed installer, and
making the user device delete the installer from the medium after the software package is installed.

18. The software license management method according to claim 17, further comprising the steps of:
making the user device write the installer from the user device to the medium if requested to uninstall the software package;
making the user device uninstall the software package from itself; and
making the user device delete the installer from itself after the software package is uninstalled.

19. A recording medium containing a program for making a computer execute processes including the steps of:
connecting via the Internet to a server that manages each medium containing a software package, when the user device is requested to install the software package which is running an installer builder contained in the medium;
requesting the installer from the server, and thereby checking whether the software package has been installed on the user device from the medium;
downloading the installer from the server and installing the software package from the medium by executing the downloaded installer if the check reveals that the software package has not been installed on the user device; and
notifying the server about the completion of the installation of the software package after the installation in order for the software package contained in the medium to be managed as having been installed on the user device.

20. The recording medium according to claim 19, wherein the program further comprises the steps of:
sending an error message, stating that the software package has been installed, if the check reveals that that the software package has been installed; and
prohibiting the software package from being installed on the computer from the medium if the error message is received.

21. The recording medium according to claim 19, wherein the program further comprises the steps of:
uninstalling the software package from the computer by executing the installer downloaded onto the computer when there is a request to uninstall the software package; and
notifying the server connected to the Internet about the completion of the uninstallation of the software package after the uninstallation in order for the software package contained in the medium to be managed as being not installed on the computer.

22. The recording medium according to claim 20, wherein the program further comprises the steps of:
uninstalling the software package from the computer by executing the installer downloaded onto the computer when there is a request to uninstall the software package; and
notifying the server connected to the Internet about the completion of the uninstallation of the software package after the uninstallation in order for the software package contained in the medium to be managed as being not installed on the computer.

23. A recording medium containing a program for making a computer execute processes including the steps of:
installing an installer on the computer from a medium if a software package is requested to be installed from the medium,
installing the software package on the computer from the medium by running the installed installer, and
deleting the installer from the medium after installing the software package.

24. The recording medium according to claim 23, wherein the program further comprises the steps of:
writing the installer from the computer to the medium if the software package is requested to be uninstalled;
uninstalling the software package from the computer; and
deleting the installer from the computer after the software package is uninstalled.
